(19) United States
(12) Patent Application Publication
(10) Pub. No.: US 2021/0355004 A1
(43) Pub. Date: Nov. 18, 2021

(54) Method for dewatering or removing solids, including corn solids, via flocculation from an alkaline aqueous solution, including nejayote, generated in the process of nixtamalization of corn by introducing a source of carbonate to the aqueous solution, followed by adding an anionic and then a cationic flocculent to the aqueous solution.

(71) Applicant: Fife Water Services, Inc., O'Fallon, MO (US)

(72) Inventors: James R. Duffy, Elsberry, MO (US); Paul Juranek, Gilbert, AZ (US)

(21) Appl. No.: 15/929,709

(22) Filed: May 18, 2020

(51) Int. Cl. C02F 1/56; C02F 1/52; A23K 10/37

(52) U.S. Cl. CPC C02F 1/56; C02F 1/5272; C02F 2103/32; C02F 2209/06; C02F 2209/02; A23K 10/37

(57) ABSTRACT

A method for removing solids via coagulation and flocculation from aqueous solutions that are generated in the process of producing corn flour called nixtamalization. This method for separating liquids/solids is especially effective in removing solids via coagulation flocculation in the process called nixtamalization in which maize is processed at high temperatures in a highly alkaline solution.

A source of carbonate alkalinity is first introduced into the waste stream (called nejayote) that is generated in the process of the nixtamalization of corn, which causes a drop in pH, and is then followed by an anionic flocculant and last of all followed by a cationic flocculant which creates a solid floc of superior strength, which allows the solids to be separated (dewatered) from the water with a high efficiency.

The addition of a source of carbonate alkalinity (coagulant) followed by an anionic and then a cationic flocculant creates a floc of superior strength versus prior art of using a coagulant and anionic flocculant or an anionic flocculant alone and therefore the solid liquid separation process is more effective on dewatering devices. When flocculants are GRAS (Generally Recognized as Safe), the recovered solids can be utilized as an animal food source which has economic benefits from a waste disposal perspective.

### REFERENCES CITED

### U.S. Patent Documents

U.S. Pat. No. 7,497,455B2 Dec. 15, 2006 Scheimann/Kowalski
U.S. Ser. No. 14/765,256/10011509 Jan. 31, 2014 Asaf-Torres/Reyes-Vidal

### SPECIFICATIONS

### Definition of Terms

1.) Purifying—Removing a component or components from a mixture that are not desirable.
2.) Contaminated—A mixture that has components that are not desirable.
3.) Coagulum—The formation of a mass from many tiny particles.
4.) In-Situ—A process that occurs in its original location.
5.) Salt of Carbonic Acid—Any compound that contains and/or adds a carbonate ion to a solution of water. Some examples of such substances include: soda ash, calcium carbonate, sodium bicarbonate and carbon dioxide. These examples are not inclusive of all such compounds.
6.) Polymer—A molecule with a repeating chain composed of a backbone of a common monomer. In this invention, the backbone is acrylamide. A polymer of cationic charge has molecules with a positive charge attached to the acrylamide backbone. A polymer with a negative charge has molecules with a negative charge attached to the acrylamide backbone.
7.) Anionic Flocculant—A repeating polymer chain of varying length with components that have negative charges on a repeating basis. These compounds attach to smaller particles with a positive charge to form larger particles that settle more quickly in water.
8.) Cationic Flocculant—A repeating polymer chain of varying length with components that have positive charges on a repeating basis. These compounds attach to smaller particles with a negative charge to form larger particles that settle more quickly in water.
9.) Floc—A larger particle created by the use of flocculants.
10.) Nixtamalization—A process for making corn flour (masa) which adds corn to a hot water solution of lime. The corn is allowed to soak and is then ground in mills, drained and the solids are dried to create the corn flour which is used to make tortillas (Masa).
11.) Nejayote—The water slurry (waste stream) containing solids that are created during the process of manufacturing Masa in the nixtamalization process.
12.) pH—A unit of measure defining how alkaline or acidic is a body of water.
13.) Dewatering device—A method of removing excess water from a slurried solid by using gravity drainage or applying force to the solid material to remove more water.
14.) Dewatered Solids—Material that has passed thru a dewatering device to reduce the moisture content.
15.) Animal feed—Any substance that has nutritional value that will contribute to the health and growth of animal livestock.

### BACKGROUND OF THE INVENTION

### Field of the Invention

The proposed invention consists of a new method to more efficiently separate the solid waste generated during the process in which corn flour is produced by nixtamalization.

### Background

Nixtamilization is the process commonly used to produce corn flour. Food grade corn is added to a hot solution of water containing calcium hydroxide (lime) at an elevated temperature (70-90 C). This softens the corn which is then milled. The milled corn is then processed thru a dryer to produce corn flower and in the process, a waste stream is generated from the milling process. The waste stream primarily consists of water heavily contaminated with corn solids. The corn solids are very difficult to treat and remove.

Typically, this waste stream passes thru some type of dewatering device before going to a biological wastewater treatment plant that reduces TSS, BOD and TKN. Current dewatering devices are very inefficient and can only remove 10-20% of the solids. This means the cost of running a biological treatment plant is high due to loading and solids accumulation which eventually leads to expensive dredging of lagoons on a 5 to 10-year timeline.

Another method to treat contaminated water is described in U.S. Pat. No. 7,497,455B2. The patent describes the use of anionic flocculants and other microparticle aids and coagulants that improve the separation of solids in the thin stillage generated in the ethanol dry grind process. The thin stillage generated in the ethanol process is at a pH of 4.0 to 4.7 which is much different than the high pH seen in the nixtamalization process, where pH is in the range of 12 to 12.5. This method requires large decreases in the pH of the contaminated water which is expensive and difficult.

Another proposed method to treat contaminated water is described in U.S. patent Ser. No. 14/765,256 which describes a method to clean up the water to standards that will allow direct discharge to water streams. The proposed process in this patent reduces the pH to a range of 6 to 8 with sulfuric acid and then enzymatically treats the waste to make it more amenable to treatment with cationic/anionic flocculants and other dewatering/settling aids such as clays. After reducing the solid loading, the clarified waste is processed thru ultrafiltration membrane systems to produce fractionated value-added organic coproducts.

### SUMMARY OF THE INVENTION

The proposed invention consists of a new method to more efficiently separate the solid waste present in water and generated during the process in which corn flour is produced by nixtamalization. The purpose of this invention is to provide a simple method to more effectively remove the solids loading and reduce the associated costs (short and long term) with the downstream operation of running a biological wastewater treatment system. The benefits of this invention versus current practices are as follows:
1.) Simple and easy to implement and operate at a milling facility.
2.) Improves solids removal efficiency in the range of 70 to 80 percent versus current technology of 10 to 20 percent.
3.) Higher solids removal reduces cost to operate a biological treatment system downstream (aeration) thru BOD reduction and the associated surcharges of sending this waste to a POTW.
4.) Higher solids removal results in less frequent dredging of lagoons to remove solids or eliminate the building of new lagoons.
5.) Reduction in solids disposal cost by generating a solid waste that can be utilized as a component in animal feed if coagulants and flocculants are GRAS approved.

The proposed invention is better suited for the nixtamalization process than the method described in the ethanol process (U.S. Pat. No. 7,497,455B2). This approach describes treating waste at the low pH typical in the ethanol production process (4.0-4.7). It is not practical to reduce the pH to this low of a level because of the cost associated with the sulfuric acid and then the need to raise the pH again to provide alkalinity for the biological treatment system. The proposed invention is also superior to the method described in U.S. Ser. No. 14/765,256 because the capital cost and operating cost will be much lower. Most importantly, the proposed invention is much easier to operate due to its simplicity of design than the complexity proposed in U.S. Ser. No. 14/765,256.

### DESCRIPTION OF DRAWING

FIG. 1 shows the steps in the process for one of the embodiments of the proposed invention which is the preferred embodiment.

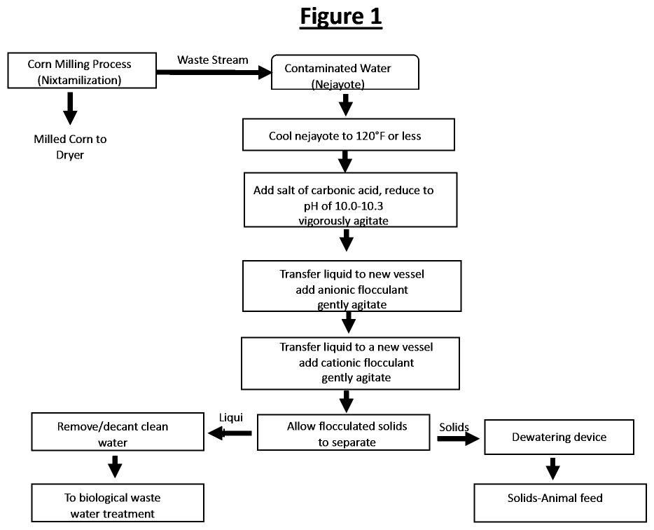

### DETAILED DESCRIPTION

The invention consists of a new, simpler method to more efficiently separate the solid waste (including corn solids) generated during the process in which corn flour is produced by nixtamalization.

One method of removing the solids from this aqueous waste stream is to install equipment such as a centrifuge, belt press, screw press (but not limited to these types of liquid-solid separation equipment) options to remove solids before or after chemical pretreatment. This chemical pretreatment typically consists of some type of pH adjustment specifically with the salt of a carbonic acid followed by an anionic and then cationic flocculant. The salt of the carbonic acid creates an in situ coagulum, a process which creates larger solids that when flocculated, are more resistant to shear allowing them to be dewatered on the appropriate equipment.

The proposed invention and method adds a salt of carbonic acid (examples include but are not limited to carbon dioxide, calcium carbonate, sodium carbonate, sodium bicarbonate, and soda ash) after allowing the temperature of the waste stream to drop below 120 F, into a rapidly agitated tank. Since the pH of the contaminated water to be treated is often in a range of 12 to 12.5, the salt of the carbonic acid causes a drop in the pH. After the pH becomes stable (in a range between 8.0 to 10.5), with an optimum range of 10 to 10.3, the aqueous mixture develops colloidal particles (coagulum) as a result of the precipitation of calcium and magnesium compounds. This is like what happens during the process of hot lime softening.

Once the coagulum has formed, the treated waste stream is transferred to a 2^{nd} tank or vessel where a high molecular weight anionic flocculant, (with a charge in the range of 10-50% on a mole basis) is added at a rate of 20 to 1000 ppm (active basis) while gently mixing. The small coagulum particles will start to get larger over a period of several minutes. The proper dosage will create a large stable particle.

The final step in the invention is to gently transfer the anionic flocculated stream to a 3^{rd} vessel while adding a high charge (>50% mole basis), high molecular weight flocculant at a rate of 20-1000 ppm while gently mixing. The addition of the cationic flocculant creates a more shear resistant particle.

From the waste stream contaminated with corn particles, the precipitated waste, removed from the contaminated water, can be used as animal feed, if the flocculants used are nonpoisonous.

So the proposed invention, is a cheaper and more efficient means to purify contaminated water, including nejayote, and results in animal feed. The proposed invention takes contaminated water, purifies the contaminated water and produces animal feed.

The invention is not limited to the structures, methods, and instrumentalities described herein and shown in the drawings. The invention is defined by the claims set forth in this application and subsequent patent.

1. A method for purifying a contaminated liquid, the method comprising: first promoting the formation of a coagulum in situ by the addition of the salt of a carbonic acid to the contaminated liquid; second followed by the addition of a anionic flocculant to the contaminated liquid; and third the addition of a cationic flocculant to the contaminated liquid.

2. The method of purifying a contaminated liquid of claim 1, with the contaminated liquid being water.

3. The method of purifying a contaminated liquid of claim 1, with the contaminated liquid being nejayote generated from the nixtamalization of corn.

4. A method of purifying a contaminated liquid comprising the following steps:
Placing the contaminated liquid in a holding tank;
Adding the salt of a carbonic acid to the contaminated liquid while in the holding tank;
Then adding an anionic flocculant to the contaminated liquid in the holding tank to create a floc;
Then adding a cationic flocculant to the contaminated liquid in the holding tank;
Then allowing the contaminants in the contaminated liquid to to floc; and
Then separating the solids from the contaminated liquid.

5. The method of purifying a contaminated liquid of claim 4, with the contaminated liquid being water.

6. The method of purifying a contaminated liquid of claim 5, with the contaminated liquid being nejayote.

7. The method of purifying a contaminated liquid of claim 6, further comprising a step of adjusting the temperature of the contaminated liquid before adding the salt of the carbonic acid.

8. The method of purifying a contaminated liquid of claim 7, further comprising a step of adjusting the temperature to 120 degrees Fahrenheit or less of the contaminated liquid before adding the salt of the carbonic acid.

9. The method of purifying a contaminated liquid of claim 8, further comprising a step of adjusting the PH of the contaminated liquid by reducing the pH of the contaminated liquid before the addition of the anionic flocculant.

10. The method of purifying a contaminated liquid of claim 9, further comprising a step of adjusting the PH of the contaminated liquid to below 11 before the addition of the anionic flocculant.

11. A method for purifying nejayote, the method comprising the steps of:
adjusting the temperature of the nejayote;
adjusting the pH of the nejayote;
creating a coagulum in situ by the addition to the nejayote of the salt of a carbonic acid;
adding an anionic flocculant to the nejayote;
adding a cationic flocculant to the nejayote;
allowing flocculation of contaminants to occur;
separating the flocculated solids from the contaminated liquid.

12. The method of purifying nejayote of claim 11, with the temperature of the nejayote being adjusted to below 120 degrees Fahrenheit.

13. The method of purifying nejayote of claim 12, with the pH of the nejayote being adjusted to below pH 11.

14. The method purifying nejayote of claim 13, with the pH of the nejayote being adjusted to a pH range 10.0-10.3.

15. The method of purifying nejayote of claim 14, with the nejayote being placed in a tank before adding the anionic flocculant to the nejayote.

16. The method of purifying nejayote of claim 15, with the anionic flocculant added to the nejayote to a concentration range of 5-1000 ppm of the najayote.

17. The method of purifying nejayote of claim 16, with cationic flocculant added to the nejayote to a concentration range of 5-1000 ppm of the nejayote.

18. The method of purifying nejayote of claim 17, with an additional step of agitation of the nejayote after addition of the cationic flocculant.

19. The method of purifying nejayote of claim 18, with an additional step of decanting excess water after separating the flocculated solids from the contaminated liquid.

20. The method of purifying nejayote of claim 19, by utilizing a dewatering device upon the flocculated solids after separating the flocculated solids from the contaminated liquid.

21. A method for making animal feed from nejayote, the method comprising the steps of:
adjusting the temperature of the nejayote;
adjusting the PH of the nejayote;
creating a coagulum in situ by the addition to the nejayote of the salt of a carbonic acid;
adding an anionic flocculant to the nejayote;
adding a cationic flocculant to the nejayote;
allowing flocculation of contaminants to occur;
separating the flocculated solids from the contaminated liquid;
the flocculated solids being animal feed or a component of animal feed.

22. A method of making animal feed from nejayote, the method comprising the following steps:
Placing the nejayote in a holding tank;
Adding the salt of a carbonic acid to the nejayote while in the holding tank;
Then adding an anionic flocculant to the nejayote in the holding tank to create a floc;
Then adding a cationic flocculant to the nejayote in the holding tank;
Then allowing the contaminants in the nejayote to floc;
Then separating the solids from the contaminated liquid with the solids comprising animal feed.
